(19) United States
(12) Patent Application Publication
(10) Pub. No.: US 2014/0372911 A1
(43) Pub. Date: Dec. 18, 2014

(54) INTERACTIVE INTERFACE DISPLAY CONTROL METHOD, INSTANT COMMUNICATION TOOL AND COMPUTER STORAGE MEDIUM

(71) Applicant: TENCENT TECHNOLOGY (SHENZHEN) COMPANY LIMITED, Guangdong (CN)

(72) Inventors: Zhongnan LI, Guangdong (CN); Xin JIN, Guangdong (CN); Lei LI, Guangdong (CN); Wenxiang WANG, Guangdong (CN); Yida DING, Guangdong (CN); Wentao WANG, Guangdong (CN); Shourun ZENG, Guangdong (CN); Yan CHEN, Guangdong (CN); Junbiao CHEN, Guangdong (CN); Guang YANG, Guangdong (CN); Yecheng XIAN, Guangdong (CN); Zurong WU, Guangdong (CN); Shundong GAO, Guangdong (CN); Yehui LIN, Guangdong (CN)

(21) Appl. No.: 14/477,320

(22) Filed: Sep. 4, 2014

Related U.S. Application Data
(63) Continuation of application No. PCT/CN2013/071867, filed on Feb. 26, 2013.

(30) Foreign Application Priority Data
Mar. 9, 2012 (CN) 201210061874.9

(51) Int. Cl. H04L 12/58; G06F 3/0481; G06F 17/30

(52) U.S. Cl. CPC H04L 51/32; G06F 17/30884; H04L 51/04; G06F 3/0481
USPC 715/753

(57) ABSTRACT

Provided is an interactive interface display control method, instant communication tool and computer storage medium. The interactive interface displayed control method, comprising the following steps: acquiring a contact list and a message of a friend in a contact list; generating an image block corresponding to the friend in the contact list; and displaying the message of the friend in the image block. The interactive interface display control method, the instant communication tool, and computer storage medium are realized by generating a corresponding image block for each friend in the contact list, and then displaying the message of the friend in the image block, thereby a user can view the message of the friend directly from the image block in the interface, which simplifies and facilities the operation.

### TECHNICAL FIELD

The present disclosure relates to data processing technology, and more particularly, to an interactive interface display control method, and an instant messaging tool and a non-transitory computer storage medium for implementing the method.

### BACKGROUND OF THE INVENTION

An instant communication tool usually shows friend information to a user in the form of a contact list, for the user to initiate instant messaging between the user and a friend. For example, each item in the contact list shows information of a friend, such as the friend's head portrait, nickname, and so on. The user can initiate a session between the user and any of the friends by clicking on the information of the friend in the contact list. When message is received from a friend, the tool will prompt the user by animation effects of the information of the friend in the contact list, such as color changing, flashing and so on. The friend information displayed in the contact list of the instant communication tool is very compendious, so as to facilitate the user to find a friend quickly, which also results in that the user cannot view more detailed dynamic status of a friend directly from the contact list.

In order to know further detailed dynamic status of a friend, the dynamic status of a friend is usually transferred in the form of a message in the network, for example, the message may be a session message between the user and the friend in a instant communication tool, or may be a dynamic message of a friend in a virtual network community. However, for a user of an instant communication tool, the message must be acquired by clicking on information of the friend in the contact list who has been prompted to the user; alternatively the user need to access the corresponding virtual network community for viewing the dynamic status of the friend, which is complicated and inconvenient to operate.

### SUMMARY OF THE INVENTION

In view of the defects mentioned above, a display control method is provided for an interactive interface, which can facilitate the operation.

An instant communication tool is also provided, which can facilitate the operation.

Provided is a computer storage medium which can facilitate the operation.

The interactive interface display control method, may include:
acquiring a contact list and a message of a friend in the contact list;
generating an image block corresponding to the friend in the contact list;
displaying the message of the friend in the image block.

The present disclosure further provides an instant communication tool, including:

a message acquiring module, configured to acquire a contact list and a message of a friend in the contact list;

an image block processing module, configured to generate an image block corresponding to the friend in the contact list;

a display module, configured to display the message of the friend in the image block.

A computer storage medium is also provided for storing a computer-executable instruction, the computer-executable instruction is used to command a computer to implement an interactive interface display control method, said method includes:
acquiring a contact list and a message of a friend in the contact list;
generating an image block corresponding to the friend in the contact list;
displaying the message of the friend in the image block.

The above interactive interface display control method, the instant communication tool, and the computer storage medium are realized by generating a corresponding image block for each friend in the contact list, and then displaying the message of the friend in the image block, thereby a user can view the message of the friend directly from the image block in the interface, which simplifies and facilities the operation.

### BRIEF DESCRIPTION OF THE DRAWINGS

FIG. 1 is a flow chart illustrating the interactive interface display control method according to one embodiment of the present invention;

FIG. 2 is a flow chart illustrating the process of generating an image block corresponding to the friend in the contact list in the method as shown in FIG. 1;

FIG. 3 is schematic diagram illustrating the image blocks generated according to the message display patterns in the method according to one embodiment of the present invention;

FIG. 4 is a flow chart illustrating the process of displaying the message of the friend in the image block in the method as shown in FIG. 1;

FIG. 5 is a schematic diagram of an image block corresponding to a friend in the method according to one embodiment of the present invention;

FIG. 6 is a schematic diagram illustrating the image block as shown in FIG. 5, wherein messages are circularly displayed;

FIG. 7 is a flow chart illustrating the interactive interface display control method according to another embodiment of the present invention;

FIG. 8 is a schematic diagram illustrating an application scenario of an interface of an instant communication tool according to one embodiment of the present invention;

FIG. 9 is a simplified diagram of an interface of an instant communication tool according to one embodiment of the present invention;

FIG. 10 is a schematic diagram illustrating the arrangement of the image blocks in the screen according to one embodiment of the present invention;

FIG. 11 is a structure diagram of an instant communication tool according to one embodiment of the present invention;

FIG. 12 is a structure diagram of the image block processing module in the instant communication tool as shown in FIG. 11;

FIG. 13 is a structure diagram of the display module in the instant communication tool as shown in FIG. 11;

FIG. 14 is a structure diagram of an instant communication tool according to another embodiment of the present invention.

### DETAILED DESCRIPTION OF THE PREFERRED EMBODIMENT

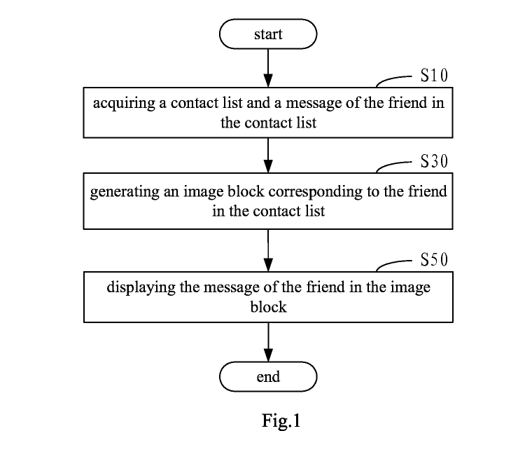

In one embodiment as shown in FIG. 1, the interactive interface display control method comprises the following steps:

Step S10, acquiring a contact list and a message of a friend in the contact list.

In this embodiment, the user establishes a connection between the instant communication tool and the instant communication server after logging in, and acquires a contact list pushed by the instant communication server. The friend information, such as head portrait, nickname, signature, online status, session messages, sequencing, and so on, is recorded in the contact list. The message of the friend in the contact list may be a session message between the user and the friend, or may be a dynamic message of the friend in a virtual network community.

Particularly, when the user's instant communication tool receives the contact list pushed by the instant communication server, it will establish a connection with at least one virtual network community server, and receive the dynamic message pushed by the virtual network community server. For example, the pushed dynamic message may be an updated log, photo, video file and so on in a page of the virtual network community.

Step S30, generating an image block corresponding to the friend in the contact list.

In this embodiment, each friend has a corresponding image block, and the corresponding information of the friend is added in the image block. The user can initiate a session by clicking on any image block in the interface of the instant communication tool, and can also browse image blocks displayed in the screen.

Step S50, displaying the message of the friend in the image block.

In this embodiment, in the image block of each friend, in addition to friend information, the message of the friend will also be displayed, for example, when a session message from a friend is received, the session message will be displayed in the image block of the friend, so that the user can acknowledge the content of the message directly from the interface of the instant communication tool, which simplifies the operation of viewing a message.

If a friend publishes a new log in the virtual network community, the new log will be displayed in the image block of the friend. The user can acknowledge the dynamic status of the friend without the need of accessing the virtual network community, which greatly facilitates the operation.

In one embodiment as shown in FIG. 2, the above step S30 is specified as follows:

Step S310, extracting friend information corresponding to a friend from the contact list

In this embodiment, each friend in the contact list has friend information corresponding thereto. The friend information corresponding to each friend is extracted from the contact list.

Step S320, judging whether the friend in the contact list has a corresponding message, if yes, then going to step S330, if not, then going to S360.

In this embodiment, not all friends in the contact list have a corresponding message, for example, if a friend neither updated his dynamic status in the virtual network community, nor initiated a session, no message is generated, accordingly, the user's instant communication tool can not acquire any message of the friend.

Judging the friends in the contact list one by one, if it is judged that a friend has a corresponding message, then it is necessary to go to step S330 to generate an image block corresponding to the message, if it is judged that the friend has no corresponding message, then going to step S360, it is only necessary to display the information of the friend in the image block.

Step S330, acquiring the message type.

In this embodiment, the message type comprises the sort of session between the user and the friend and the message source, which can be flexibly set as needed. Particularly, with respect to the session message, the message type is the sort of session between the user and the friend, such as, a file transmission message, a text message, a video play message, a photo message, a request for adding a friend, a voice message, and so on; with respect to the dynamic message of the friend in a virtual network community, the message type is the message source, that is, the virtual network community which the message comes from, such as, a micro-blog message, an XX space message, and so on.

Step S340, extracting a message display pattern corresponding to the message, and generating an image block according to the message display pattern;

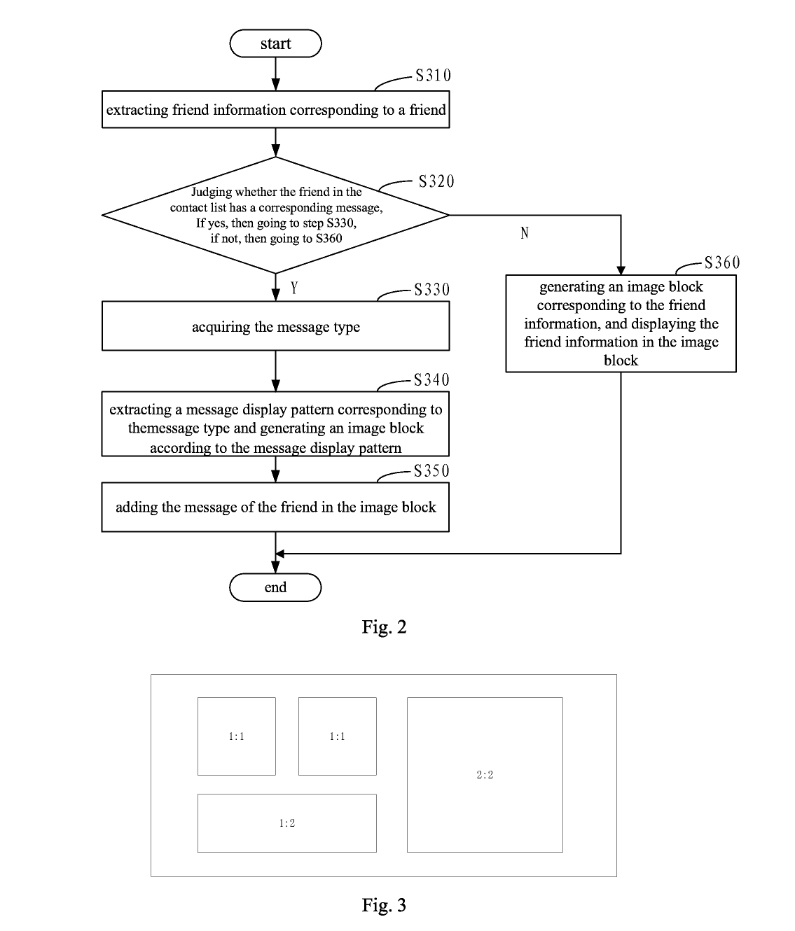

In this embodiment, the mapping relation between a message type and a message display pattern is predetermined The message display pattern comprises the information such as the size of image block, the background and so on, for determining the appearance of the image block. After acquiring the message type, extract the message display pattern corresponding thereto, and then generate an image block corresponding to the friend according to the message display pattern, for example, the size of the image block in the message display pattern may be embodied as an aspect ratio of 1:1, 1:2 or 2:2, accordingly, the image blocks are generated according to the message display patterns, as shown in FIG. 3.

When it is needed to add a new message display pattern, it can be realized by adding a new message type and the message display pattern having a mapping relation therewith into the set of predetermined mapping relations.

In another embodiment, in the acquired messages, the message corresponding to a certain friend may comprise different types of messages, accordingly, there will be more than one extracted message display patterns corresponding to the message types. In this case, the message display pattern with maximum image block size will be acquired, thereby the image block corresponding to the friend will be generated according to the message display pattern with maximum image block size.

Step S350, adding the message of the friend in the image block.

In this embodiment, the message of the friend will be added into the corresponding image block, so as to display the message of the friend in the image block.

Step S360, generating an image block corresponding to the friend information, and displaying the friend information in the image block.

In this embodiment, if it is judged that a certain friend in the contact list does not have a corresponding message, then an image block for displaying the friend information will be generated, the information display pattern of the image block can be predetermined.

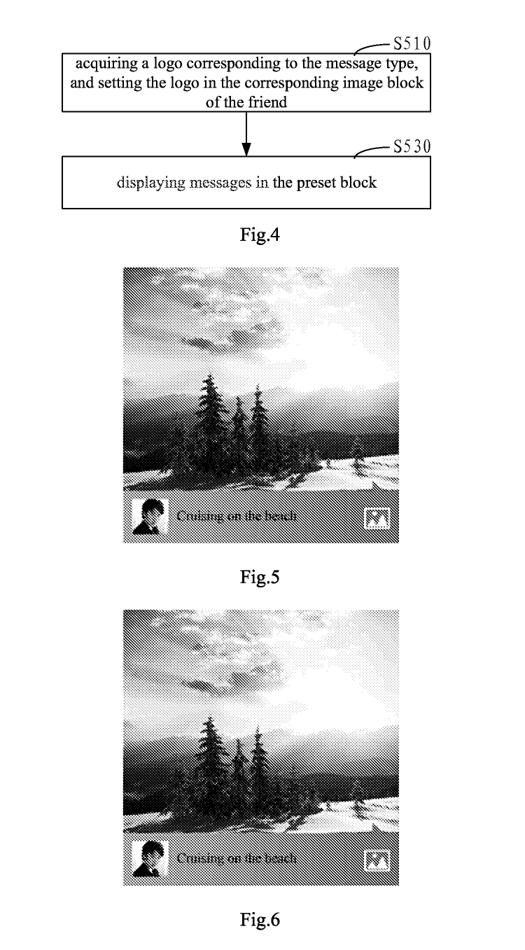

In one embodiment as shown in FIG. 4, the above step S50 is specified as follow:

Step S510, acquiring a logo corresponding to the message type, and setting the logo in the corresponding image block of the friend.

In this embodiment, set a corresponding logo in the image block, for prompting the user who is browsing messages in the image block which virtual network community a message comes from, or which sort of session a message in the image block belongs to, thereby ensures that messages are clearly displayed on the premise that the user's operation is simplified.

Step S530, displaying messages in a preset image block.

In this embodiment, the message of each friend in the instant communication tool is displayed in a corresponding image block of the friend, that is, all the unread messages are collectively displayed in image blocks. The unread messages comprise the unread session messages between the user and friends, and dynamic messages which are not viewed by the user in the virtual network community. When starting up the instant communication tool, the user can browse the dynamic status of each friend directly from the interface, and acknowledge the message type from the logo in the image block, thereby quickly and easily aggregate the virtual network community with sessions between the user and friends in the interface of the instant communication tool.

In one embodiment, the message of the friend comprises a dynamic message in the virtual network community and/or a session message, the above step S530 is specified as follows: circularly displaying multiple messages of the friend in chronological sequence.

In this embodiment, a certain friend's message acquired by the user may comprise session massages and dynamic messages in the virtual network community, in this case, the corresponding image block of the friend will circularly display multiple messages in chronological sequence. For example, as shown in FIG. 5, one friend updated an album in the virtual network community, in this case, the image block corresponding to the friend displays the updated photo in the interface of the instant communication tool, additionally, if multiple photos were updated, the image block corresponding to the friend circularly displays the multiple photos.

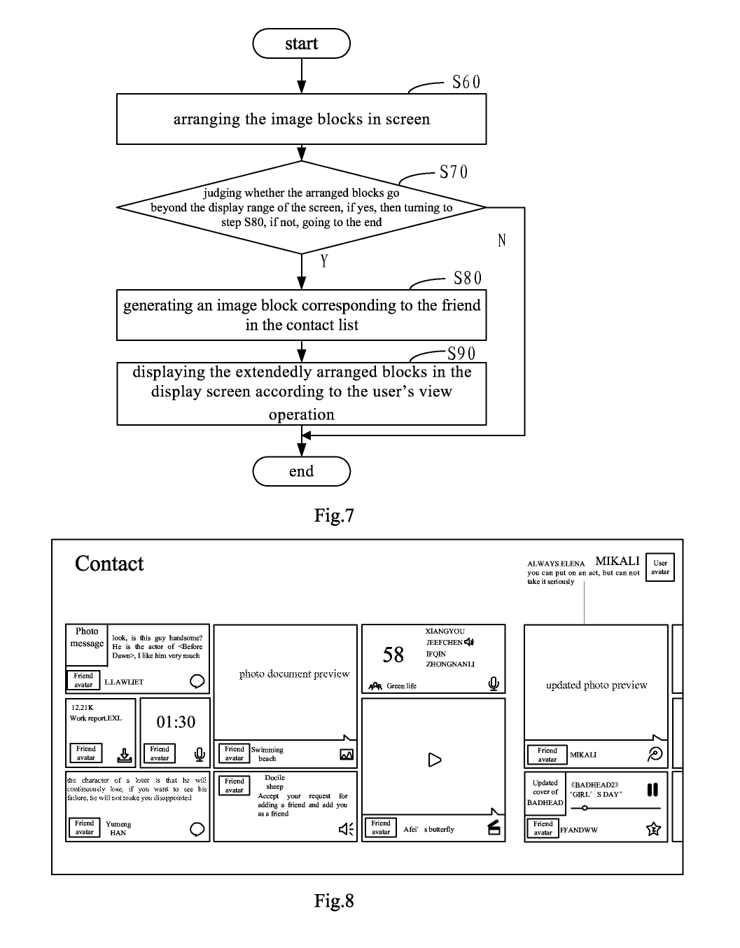

In another embodiment as shown in FIG. 7, the method, following the step S50, further comprises the follow steps:

Step S60, arranging the image blocks in the screen.

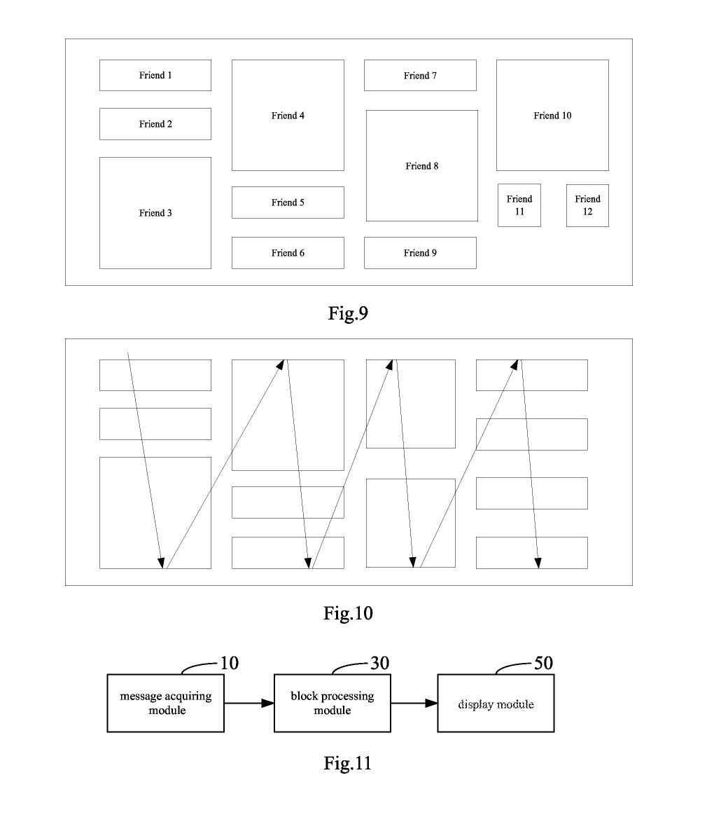

In this embodiment, each friend in the contact list of the instant communication tool corresponds to an image block. The image blocks of all friends are arranged in the screen, as shown in FIGS. 8 and 9, the contact list is converted from conventional form into the form of a combination of blocks, thereby the contents carried by the contact list are more abundant, and the form of the contact list is more free, which can not only improve the efficiency of finding a friend in the contact list, but can also enable a fast browsing for the dynamic status of friends. In one embodiment as shown in FIG. 10, all image blocks can be arranged in the sequence from up to down and then from left to right, so that the image blocks in the screen are more orderly, which further improves the user's search efficiency.

Step S70, judging whether the arranged blocks go beyond the display range of the screen, if yes, then turning to step S80, if not, going to the end.

In this embodiment, the display range is the display area of the screen. Messages of friends and the corresponding friend information are displayed via image blocks, each friend corresponds to one image block. The range of the screen is limited, and it often happens that the screen can not fully display all of the image blocks. At this time, if it is judged that the arranged image blocks go beyond the display range of the screen, the image blocks will be arranged extendedly beyond the display range. The user can view the image blocks beyond the display range by performing the rolling view operation or moving view operation on the interface of the instant communication tool.

Step S80, extendedly arranging image blocks beyond the display range.

In this embodiment, the height of the screen may be defined as the height for arranging the image blocks. The image blocks are extendedly arranged beyond the display range along the width direction, accordingly, the user can view the image blocks arranged beyond the display range by rolling the scroll bar or moving the interface of the instant communication tool in the left or right direction. Alternatively, the width of the screen may be defined as the width for arranging the image blocks. The image blocks are extendedly arranged beyond the display range along the height direction, and the user can view the image blocks arranged beyond the display range by rolling the scroll bar or moving the interface of the instant communication tool in the up or down direction.

Step S90, displaying the extendedly arranged image blocks in the display range according to the user's view operation.

In this embodiment, the extendedly arranged image blocks are triggered to be displayed in the display range of the screen by the user's view operation.

In one embodiment as shown in FIG. 11, an instant communication tool comprises a message acquiring module 10, an image block processing module 30 and a display module 50.

The message acquiring module 10 is configured to acquire a contact list and a message of a friend in the contact list.

In this embodiment, the user establishes a connection between the instant communication tool and the instant communication server after logging in, the message acquiring module 10 acquires a contact list pushed by the instant communication server. The friend information, such as head portrait, nickname, signature, online status, session messages, sequencing, and so on, is recorded in the contact list. The message of the friend in the contact list may be a session message between the user and the friend, or may be a dynamic message of a friend in a virtual network community.

Particularly, when the message acquiring module 10 receives the contact list pushed by the instant communication server, it will establish a connection with at least one virtual network community server, and receive the dynamic message pushed by the virtual network community server. For example, the pushed dynamic message may be an updated log, photo, video file, and so on in a page of the virtual network community.

The image block processing module 30 is configured to generate an image block corresponding to the friend in the contact list.

In this embodiment, each friend has a corresponding image block, and the corresponding information of the friend is added in the image block. The user can initiate a session by clicking on any image block in the interface of the instant communication tool, and can also browse image blocks displayed in the screen.

The display module 50 is configured to display the message of the fiend in the image block.

In this embodiment, in the image block of each friend, in addition to the friend information, the message of the friend will also be displayed, for example, when a session message from a friend is received, the display module 50 will display the session message in the image block of the friend, so that the user can acknowledge the content of the message directly from the interface of the instant communication tool, which simplifies the operation of viewing a message.

If a friend publishes a new log in the virtual network community, the new log will be displayed in the image block of the friend. The user can acknowledge the dynamic status of the friend without the need of accessing the virtual network community, which greatly facilitates the operation.

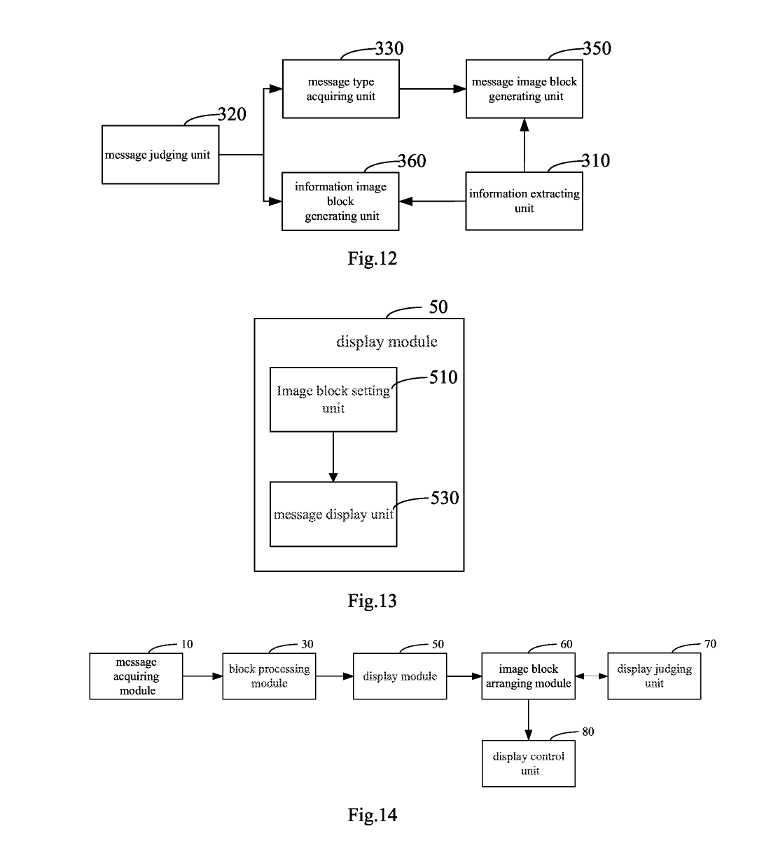

In one embodiment as shown in FIG. 12, the above block processing module 30 comprises an information extracting unit 310, a message judging unit 320, a message type acquiring unit 330, a message image block generating unit 350 and an information image block generating unit 360.

The information extracting unit 310 is configured to extract friend information corresponding to a friend from the contact list.

In this embodiment, each friend in the contact list has friend information corresponding thereto. The information extracting unit 310 extracts the friend information corresponding to each friend from the contact list.

The message judging unit 320 is configured to judge whether the friend in the contact list has a corresponding message, if yes, then it will inform the message type acquiring unit 330, if not, it will inform the information image block generating unit 360.

In this embodiment, not all friends in the contact list have a corresponding message, for example, if a friend neither updated his dynamic status in the virtual network community, nor initiated a session, no message is generated, accordingly, the user's instant communication tool can not acquire any message of the friend.

The message judging unit 320 judges the friends in the contact list one by one, if it is judged that a friend has a corresponding message, then the message type acquiring unit 330 is informed to generate an image block corresponding to the message, if it is judged that the friend has no corresponding message, then the information image block generating unit 360 displays the information of the friend in the image block.

The message type acquiring unit 330 is configured to acquire the message type.

In this embodiment, the message type comprises the sort of session between the user and the friend and the message source, which can be flexibly set as needed. Particularly, with respect to the session message, the message type is the sort of session between the user and the friend, such as, a file transmission message, a text message, a video play message, a photo message, a request for adding a friend, a voice message, and so on; with respect to the dynamic message of the friend in a virtual network community, the message type is the message source, that is, the virtual network community which the message comes from, such as a micro-blog message, an XX space message, and so on.

The message image block generating unit 350 is configured to extract a message display pattern corresponding to the message, generate an image block according to the message display pattern, and add the message of the friend in the image block.

In this embodiment, the mapping relation between a message type and a message display pattern is predetermined The message display pattern comprises the information such as the size of image block, the background and so on, for determining the appearance of the image block. After acquiring the message type, the message image block generating unit 350 extracts the message display pattern corresponding thereto, then generates an image block corresponding to the friend according to the message display pattern, and adds the message of the friend in the image block so as to display the message of the friend in the image block. For example, the size of the image block in the message display pattern may be embodied as an aspect ratio of 1:1, 1:2 or 2:2, accordingly, the message image block generating unit 350 generates image blocks according to the message display patterns.

When it is needed to add a new message display pattern, it can be realized by adding a new message type and the message display pattern having a mapping relation therewith into the set of predetermined mapping relations.

In another embodiment, in the acquired messages, the message corresponding to a certain friend may comprise different types of messages, accordingly, more than one message display patterns corresponding to the message types will be extracted by the message image block generating unit 350. In this case, the message display pattern with maximum image block size will be acquired, thereby the image block corresponding to the friend will be generated according to the message display pattern with maximum block size.

The information image block generating unit 360 is configured to generate an image block corresponding to the friend information, and display the friend information in the image block.

In this embodiment, if it is judged that a certain friend in the contact list does not have a corresponding message, then the information image block generating unit 360 will generate an image block for displaying the friend information, the information display pattern of the image block can be predetermined.

In one embodiment as shown in FIG. 13, the above display module 50 comprises an image block setting unit 510 and a message display unit 530.

The image block setting unit 510 is configured to acquire a logo corresponding to the message type, and set the logo in the image block corresponding to the friend.

In this embodiment, the image block setting unit 510 sets a corresponding logo in the image block, for promoting the user who is browsing messages displayed in the image block which virtual network community a message comes from, or which sort of session a message in the image block belongs to, thereby ensures that messages are clearly displayed on the premise that the user's operation is simplified.

The message display unit 530 is configured to display messages in a preset image block.

In this embodiment, the message of each friend in the instant communication tool is displayed in a corresponding image block of the friend, that is, all the unread messages are collectively displayed in image blocks. The unread messages comprise the unread session messages between the user and friends, and dynamic messages which are not viewed by the user in the virtual network community. When starting up the instant communication tool, the user can browse the dynamic status of each friend directly from the interface, and acknowledge the message type from the logo in the image block, thereby quickly and easily aggregate the virtual network community with sessions between the user and friends in the interface of the instant communication tool.

In one of the embodiments, the message from a friend comprises a dynamic message in the virtual network community and/or a session message, in this case, the above message display unit 530 will circularly display multiple messages of the friend in chronological sequence.

As shown in FIG. 14, the above instant communication tool further comprises an image block arranging module 60, a display judging unit 70, and a display control unit 80.

The image block arranging module 60 is configured to arrange the image blocks in the screen.

In this embodiment, each friend in the contact list of the instant communication tool corresponds to an image block, the image block arranging module 60 arranges image blocks of all the friends in the screen, the contact list is converted from the conventional form into the form of a combination of blocks, thereby the contents carried by the contact list are more abundant, and the form of the contact list is more free, which can not only improve the efficiency of finding a friend in the contact list, but can also enable a fast browsing for the dynamic status of friends. In one embodiment, the image block arranging module 60 can arrange all blocks in a sequence from up to down and then from left to right, so that the image blocks in the screen are more orderly, which further improves the user's search efficiency.

The display judging unit 70 is configured to judge whether the arranged blocks go beyond the display range of the screen, if yes, inform the image block arranging module 60, if not, go to the end.

In this embodiment, the display range is the display area of the screen. The messages of friends and the corresponding friend information are displayed via image blocks, each friend corresponds to one image block. The range of the screen is limited, and it often happens that the screen cannot fully display all of the image blocks. At this time, if the display judging unit 70 judges that the arranged image blocks go beyond the display range of the screen, the image blocks will be arranged extendedly beyond the display range. The user can view the image blocks beyond the display range by performing the rolling view operation or moving view operation on the interface of the instant communication tool.

The image block arranging module 60 is further configured to extendedly arrange blocks beyond the display range.

In this embodiment, the height of the screen may be defined as the height for arranging the image blocks. The image block arranging module 60 will extendedly arrange the image blocks beyond the display range along the width direction, accordingly, the user can view the image blocks arranged beyond the display range by rolling the scroll bar or moving the interface of the instant communication tool in the left or right direction. Alternatively, the width of the screen may be defined as the width for arranging the image blocks. The image block arranging module 60 will extendedly arrange the image blocks beyond the display range along the height direction, and the user can view the image blocks arranged beyond the display range by rolling the scroll bar or moving the interface of the instant communication tool in the up or down direction.

The display control unit 80 is configured to display the extendedly arranged image blocks in the display range according to the user's view operation.

In this embodiment, the display control unit 80 triggers the extendedly arranged image blocks to be displayed in the display range of the screen by means of the user's view operation.

The above interactive interface display control method, the instant communication tool, and computer storage medium are realized by generating a corresponding image block for each friend in the contact list, and then displaying the message of the friend in the image block, thereby a user can view the message of the friend directly from the image block in the interface, which simplifies and facilities the operation.

The present disclosure also provides a computer storage medium storing computer-executable instructions, the computer-executable instruction is used to command a computer to implement an interactive interface display control method. The specific steps of the interactive interface display control method implemented by the computer-executable instruction in a computer storage medium have been described above, and will not be repeated herein.

The above embodiments are only several implementations of the present disclosure, which are described specifically and in details, however, they are not intended to limit the scope of the present disclosure. It should be pointed out that, various modifications and improvements to the present disclosure can be made by the person skilled in the art without departing from the spirit of the present disclosure, which also belong to the scope of the present disclosure. Therefore, the protection cope of the present disclosure should be defined by the attached claims.

1. An interactive interface display control method, comprising following steps:
acquiring a contact list and a message of a friend in the contact list;
generating an image block corresponding to the friend in the contact list; and
displaying the message of the friend in the image block.

2. The interactive interface display control method according to claim 1, wherein, the step of generating an image block corresponding to the friend in the contact list comprises:
extracting friend information corresponding to the friend from the contact list;
judging whether the friend in the contact list has a corresponding message, if yes, then acquiring a message type of the message;
extracting a message display pattern corresponding to the message type and generating an image block according to the message display pattern;
adding the message of the friend in the image block.

3. The interactive interface display control method according to claim 2, wherein, the step of generating an image block corresponding to the friend in the contact list comprises:
if it is judged that the friend in the contact list has no corresponding message, then generating an image block corresponding to the friend information and display the friend information in the image block.

4. The interactive interface display control method according to claim 2, wherein, the step of displaying the message of the friend in the image block comprises:
acquiring a logo corresponding to the message type, and setting the logo in the image block of the friend;
displaying the message in the image block.

5. The interactive interface display control method according to claim 4, wherein, the message of the friend comprises a dynamic message in a virtual network community and/or a session message; said displaying the message in the image block is specified as follows:
circularly displaying multiple messages of the friend in chronological sequence.

6. The interactive interface display control method according to claim 1, wherein, following the step of displaying the message of the friend, the display control method further comprises following steps:
arranging image blocks in a screen;
judging whether the image blocks arranged go beyond a display range of the screen, if yes, extendedly arranging the image blocks beyond the display range;
displaying extendedly arranged image blocks in the display range of the screen according to a user's view operation.

7. The interactive interface display control method according to claim 6, wherein, the step of extendedly arranging the image blocks beyond the display range comprises:
defining a height or width of the screen as a height or width for arranging the image blocks, and extendedly arranging the image blocks beyond the display range along a direction of the height or width.

8. An instant communication tool, comprising:
a message acquiring module, configured to acquire a contact list and a message of a friend in the contact list;
an image block processing module, configured to generate an image block corresponding to the friend in the contact list;
a display module, configured to display the message of the friend in the image block.

9. The instant communication tool according to claim 8, wherein, the image block processing module comprises:
an information extracting unit, configured to extract friend information corresponding to the friend from the contact list;
a message judging unit, configured to judge whether the friend in the contact list has a corresponding message, if yes, then inform a message type acquiring unit;
the message type acquiring unit, configured to acquire a message type;
a message image block generating unit, configured to extract a message display pattern corresponding to the message, generate an image block according to the message display pattern, and add the message of the friend in the image block.

10. The instant communication tool according to claim 9, wherein, the image block processing module further comprises:
an information image block generating unit, configured to generate an image block corresponding to the friend information if it is judged that the friend in the contact list does not have a corresponding message, and display the friend information in the image block.

11. The instant communication tool according to claim 9, wherein, the display module comprises:
an image block setting unit, configured to acquire a logo corresponding to the message type, and set the logo in the image block of the friend;
a message display unit, configured to display the message in the image block.

12. The instant communication tool according to claim 11, wherein, the message of the friend comprises a dynamic message in a virtual network community and/or a session message, the message display unit is also configured to circularly display multiple messages of the friend in chronological sequence.

13. The instant communication tool according to claim 8, further comprising:
an image block arranging module, configured to arrange image blocks in a screen;
a display judging unit, configured to judge whether the image blocks arranged go beyond a display range of the screen, if yes, then inform the image block arranging module;
the image block arranging module is also configured to extendedly arrange image blocks beyond the display range;
a display control unit, configured to display extendedly arranged image blocks in the display range of the screen according to a user's view operation.

14. The instant communication tool according to claim 8, wherein, the image block arranging module is also configured to define a height or width of the screen as a height or width for arranging the image blocks, and extendedly arrange the image blocks beyond the display range along a direction of the height or width.

15. A non-transitory computer storage medium for storing a computer-executable instruction, the computer-executable instruction is used to command a computer to implement an interactive interface display control method, said method comprises:
acquiring a contact list and a message of a friend in a contact list;
generating an image block corresponding to the friend in the contact list; and
displaying the message of the friend in the image block.
